(19) United States
(12) Patent Application Publication
(10) Pub. No.: US 2011/0304563 A1
(43) Pub. Date: Dec. 15, 2011

(54) TOUCH DISPLAY PANEL AND TOUCH SENSOR STRUCTURE THEREOF

(76) Inventors: Tsung-Chin Cheng, Hsin-Chu (TW); Zeng-De Chen, Hsin-Chu (TW); Seok-Lyul Lee, Hsin-Chu (TW)

(21) Appl. No.: 12/947,840

(22) Filed: Nov. 17, 2010

(30) Foreign Application Priority Data
Jun. 11, 2010 (TW) 099119080

(51) Int. Cl. G06F 3/041; G01D 21/00

(52) U.S. Cl. 345/173; 73/865.8

(57) ABSTRACT

A touch sensor structure includes a first substrate, a second substrate, a first stage, and a conductive spacer. The first substrate and the second substrate are disposed oppositely. The first stage is disposed on the first substrate, facing the second substrate. The first stage includes at least one supporting structure, a sensing structure, and a conductive sensing pad disposed on the sensing structure. The conductive spacer is disposed on the second substrate, facing the first substrate, where the conductive spacer is corresponding to the first stage.

### BACKGROUND OF THE INVENTION

1. Field of the Invention

The present invention is related to a touch display panel and a touch sensor structure thereof, and more particularly, to a touch display panel and the touch sensor structure thereof with a stage, which is constructed by supporting structures and sensing structures. The touch display panel and the touch sensor structure thereof have durability and good touch sensing sensitivity.

2. Description of the Prior Art

In all kinds of the consumer electronic products nowadays, the portable electronic products, such as personal digital assistant (PDA), mobile phone and notebooks, have adopted touch panel as the interface tool between users and electronic devices. The existing designs of the electronic products trend to being thin, light, short, and small, and therefore the product designs are hoped to conserve the space for the conventional input devices, such as keyboard and mouse. Specifically, by the popular demand for the user-friendly tablet computers, the display device combining touch panel is becoming one of the key components of all kinds of the electronic products.

Recently, attempts have been made to integrate a touch function into a liquid crystal display panel. The touch input function can be implemented by pressing the liquid crystal display and making the upper substrate of the display panel have a sagging deformation to generate a sensing signal. Please refer to FIG. 1. FIG. 1 illustrates a schematic diagram of a circuit structure of a conventional touch display panel 10. As shown in FIG. 1, the conventional touch display panel 10 includes a plurality of display areas 16 and a plurality of sensing areas 12. Each of the display areas 16 includes a first gate line GL₁, a data line DL, a pixel switch device TFTₚᵢₓₑₗ, a storing capacitor Cst, and a liquid crystal capacitor C_{LC1}. A gate of the pixel switch device TFTₚᵢₓₑₗ is electrically connected to the first gate line GL₁, a source of the pixel switch device TFTₚᵢₓₑₗ is electrically connected to the data line DL, and a drain of the pixel switch device TFTₚᵢₓₑₗ is electrically connected to a pixel electrode 18. When display is implemented, a data signal carried by the data line DL is transferred to the pixel electrode 18 through the pixel switch device TFTₚᵢₓₑₗ and the data signal of the pixel electrode 18 and a common voltage V_{com} of a common electrode 20 of the upper substrate may generate the liquid crystal capacitor C_{LC1} so that the direction of the liquid crystal is changed and then the visual image is exhibited. On the other hand, the sensing area 12 includes a touch signal read-out line RL, a second gate line GL₂, a sensing structure C_{LC2}, and a touch signal read-out switch device TFT_{Readout}. A gate of the touch signal read-out switch device TFT_{Readout} is electrically connected to the second gate line GL₂, a source of the touch signal read-out switch device TFT_{Readout} is electrically connected to the sensing structure C_{LC2}, and a drain of the touch signal read-out switch device TFT_{Readout} is electrically connected to the touch signal read-out line RL. When touch input is implemented, the upper substrate may have a sagging deformation by pressing the touch display panel 10 so that the common electrode 20 on the upper substrate will contact the touch signal read-out switch device TFT_{Readout} on the lower substrate. Consequently, the common voltage V_{com} of the common electrode 20 may pass through the touch signal read-out switch device TFT_{Readout} and the touch signal read-out line RL, and reach an amplifier 14 as a touch input signal.

Please refer to FIG. 2, FIG. 3, and FIG. 1 as well. FIG. 2 illustrates a top view of the lower substrate of the conventional touch display panel. FIG. 3 illustrates a cross-sectional view of the touch display panel along lines A-A′, B-B′, and C-C′ in FIG. 2. As shown in FIG. 2 and FIG. 3, the conventional touch display panel 10 includes a lower substrate 30, an upper substrate 32, and a liquid crystal layer 34 disposed between the lower substrate 30 and the upper substrate 32. There are a plurality of main stages 381, a plurality of sub stages 382 and a plurality of sensor stages 383 disposed on the lower substrate 30, and there are a plurality of main spacers 401, a plurality of sub spacers 402, and a plurality of sensor spacers 403 disposed on the upper substrate 32 corresponding to the main stages 381, the sub stages 382 and the sensor stages 383, respectively. The main spacer 401 is in contact with the main stage 381 for maintaining a liquid crystal cell gap of the touch display panel 10. There is a gap formed between the sub spacer 402 and the sub stage 382. When implementing touch input through pressing the upper substrate 32 of the touch display panel 10, the sub spacer 402 will contact the sub stage 382 for providing a supporting force, which avoids over-deformation of the touch display panel 10 so that the durability of the touch display panel 10 is improved. The sensing structure C_{LC2} of FIG. 1 is constructed by the sensor spacer 403 and the sensor stage 383. When implementing touch input by pressing the upper substrate 32 of the touch display panel 10, the sensor spacer 403 will also contact the sensor stage 383; meanwhile, the common voltage V_{com} of the common electrode 20 on the surface of the sensor spacer 403 will flow from the sensor stage 383 sequentially passing through the touch signal read-out device TFT_{Readout} and the touch signal read-out line RL to the amplifier 14. As a result, the exact touch input position will be calculated by the calculating unit (which is not shown in the figure).

It has been testified that the durability of the touch display panel 10 and the number of the sub spacers 402 have a positive correlation, that is to say, the more the sub spacers 402 are, the better the durability of the touch display panel 10 is. On the other hand, touch sensing sensitivity of the touch display panel 10 and the number of the sensor spacer 403 also have a positive correlation, that is to say, the more sensor spacers 403 are, the better the touch sensing sensitivity is. However, because the sub spacer 402 and the sensor spacer 403 of the conventional touch display panel 10 are independent structures disposed individually. As shown in FIG. 2, owing to a limited layout area on the touch display panel 10, there is no sufficient space for accommodating enough numbers of the sub spacers 402 and the sensor spacers 403. Consequently, there is a trade-off between the durability and the touch sensing sensitivity of the touch display panel 10.

### SUMMARY OF THE INVENTION

It is therefore one of the objectives of the present invention to provide a touch display panel and a touch sensor structure thereof for giving consideration on both durability and touch sensing sensitivity.

In accordance with an embodiment of the present invention, a touch sensor structure is provided. The touch sensor structure includes a first substrate, a second substrate, a first stage, and a conductive spacer. The first substrate and the second substrate are disposed oppositely. The first stage is disposed on the first substrate and faces the second substrate. The first stage includes at least one supporting structure, a sensing structure, and a conductive sensing pad disposed on the supporting structure. The conductive spacer is disposed on the second substrate, faces the first substrate, and is corresponding to the first stage.

In accordance with another embodiment of the present invention, a touch display panel is provided. The touch display panel includes a first substrate, a plurality of first gate lines, a plurality of data lines, a second substrate, a display medium layer, a plurality of first stages, a plurality of conductive spacers, a plurality of second stages, and a plurality of main spacers. The first gate lines and the data lines are disposed on the first substrate and are crossed to define a plurality of pixel areas on the first substrate. Each of the pixel areas includes a pixel display area and a pixel peripheral area, and the pixel peripheral area is disposed between the pixel display area and the neighboring first gate line. The first substrate and the second substrate are disposed oppositely. The display medium layer is disposed between the first substrate and the second substrate. The first stages are disposed respectively in one of the pixel peripheral areas of the first substrate and face the second substrate. Each of the first stages includes at least one supporting structure, a sensing structure, and a conductive sensing pad disposed on the supporting structure. The conductive spacers are disposed on the second substrate, face the first substrate, and are respectively corresponding to one of the first stages. The second stages are disposed in one of the pixel peripheral areas on the first substrate and face the second substrate. The main spacers are disposed on the second substrate and face the first substrate, wherein the main spacers are corresponding to and in contact with the second stages, respectively.

The first stage of the present invention includes a supporting structure and a sensing structure. The supporting structure and the conductive spacer can provide assistant supporting for prolonging the durability of the touch display panel, and the sensing structure and the conductive spacer can provide touch input function. Because the supporting structure and the sensing structure are integrated as a first stage, the present invention can dispose maximum number of the first stages with both assistant supporting and touch input functions in the limited number of the pixel peripheral areas so that the durability and the touch sensing sensitivity of the touch display panel are both improved. In other words, except for the position where the touch signal read-out switch devices and the second stages are disposed, the first stages with assistant supporting and touch input functions may be disposed throughout the first substrate. As a result, the present invention may accomplish the design of full sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a circuit structure of a conventional touch display panel.

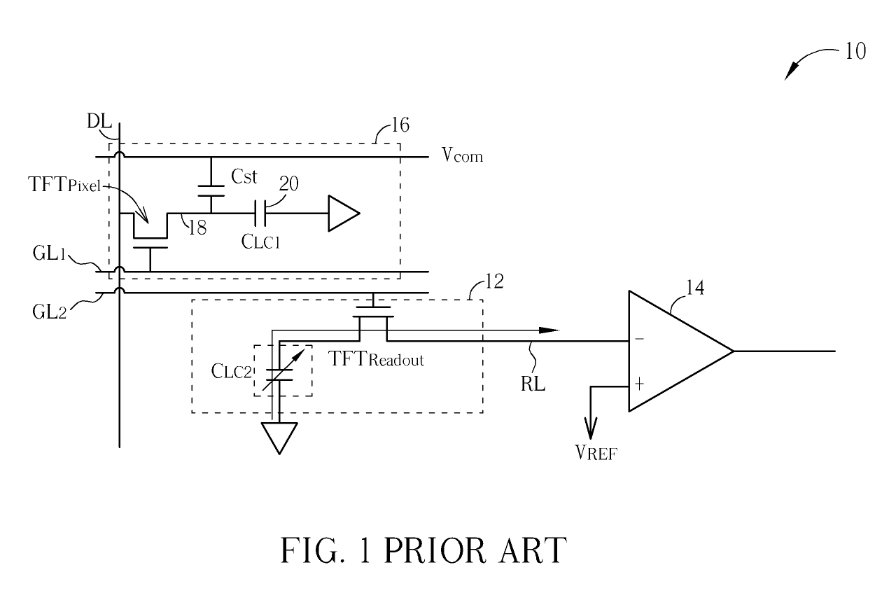

FIG. 2 illustrates a top view of the lower substrate of the conventional touch display panel.

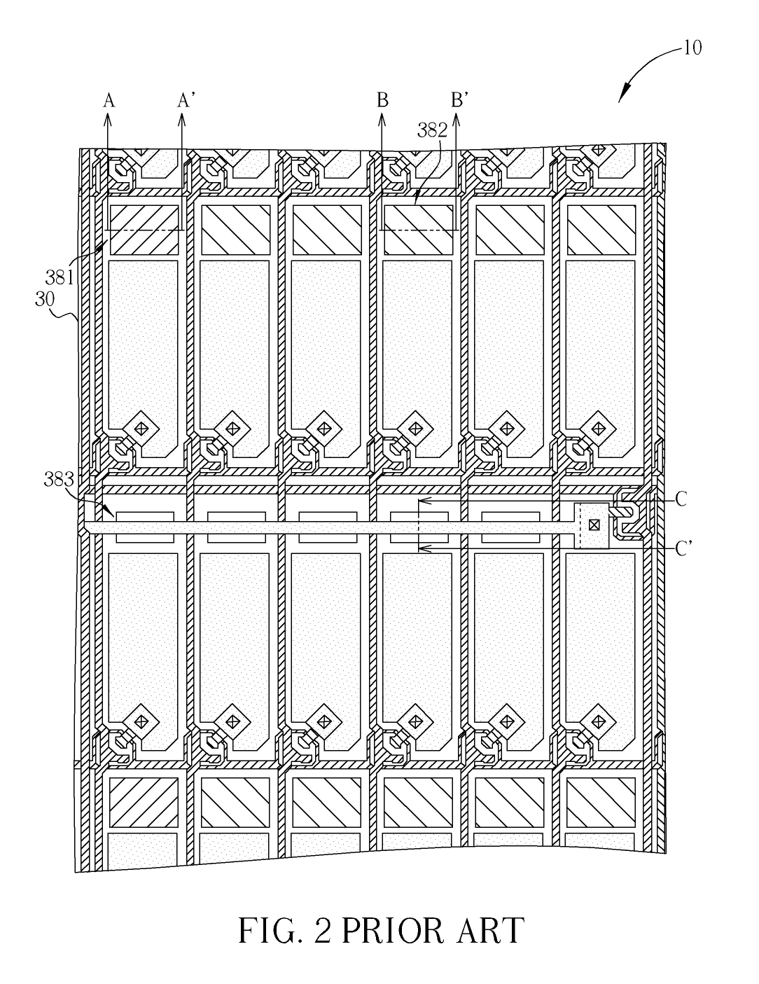

FIG. 3 illustrates a cross-sectional view of the touch display panel along lines A-A′, B-B′, and C-C′ in FIG. 2.

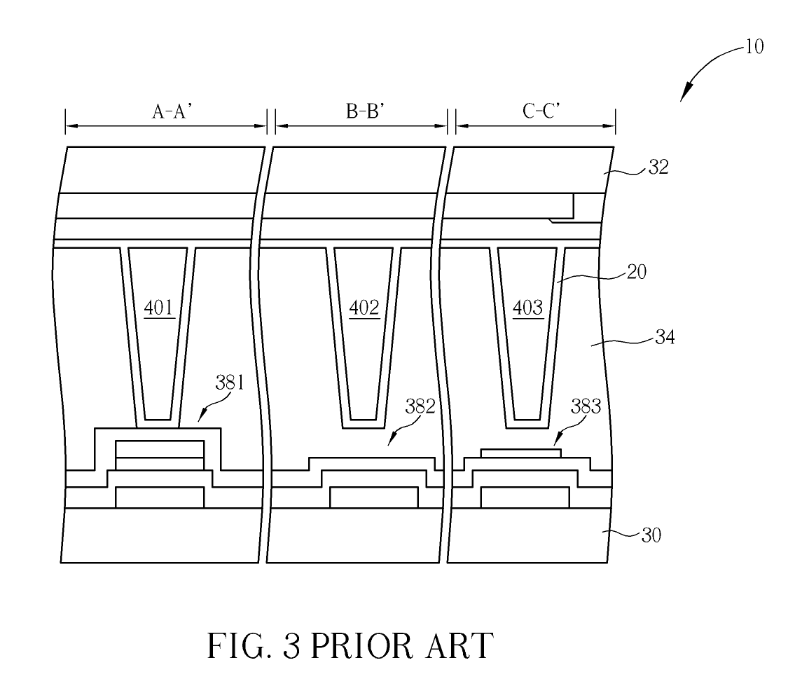

FIG. 4 illustrates a touch display panel according to a preferred embodiment of the present invention.

FIG. 5 illustrates a cross-sectional view of the touch display panel along lines D-D′ and E-E′ in FIG. 4.

FIG. 6 illustrates a top view of the first stage in the embodiment.

FIG. 7 illustrates a top view of a first stage of another embodiment of the present invention.

FIG. 8 illustrates a cross-sectional view of the first stage along line F-F′ in FIG. 7.

FIG. 9 illustrates a first stage of a variation embodiment of the present invention.

FIG. 10 illustrates a touch display panel of another preferred embodiment of the present invention.

### DETAILED DESCRIPTION

To provide a better understanding of the present invention, preferred embodiments will be made in detail. The preferred embodiments of the present invention are illustrated in the accompanying drawings with numbered elements.

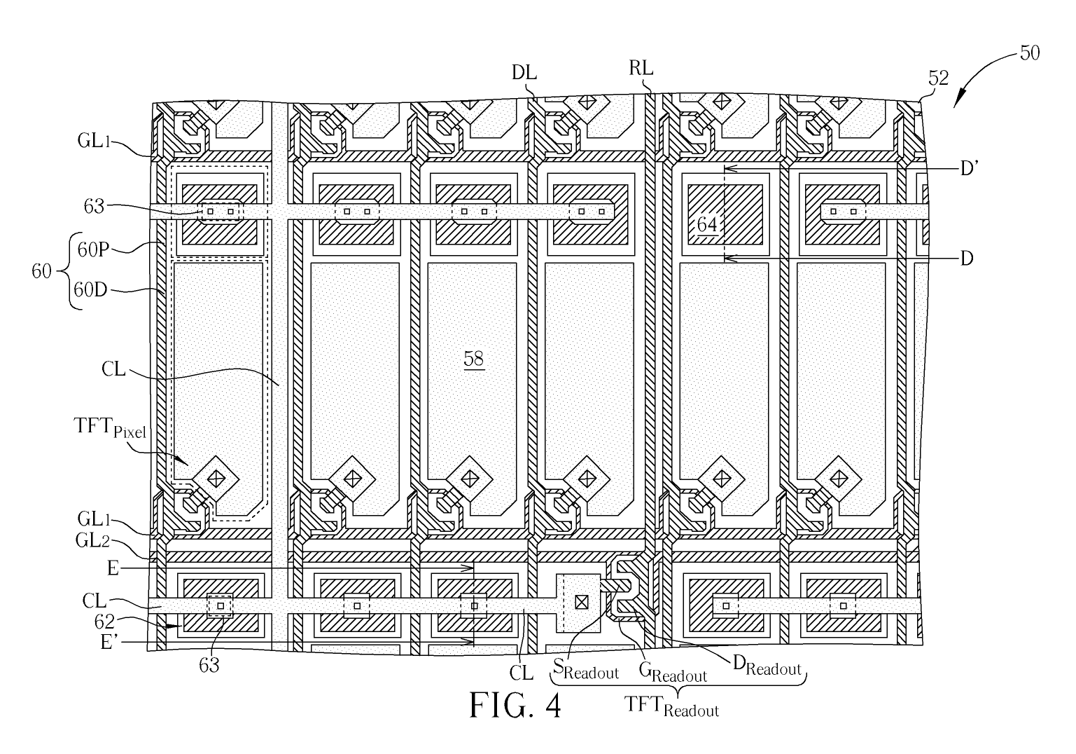

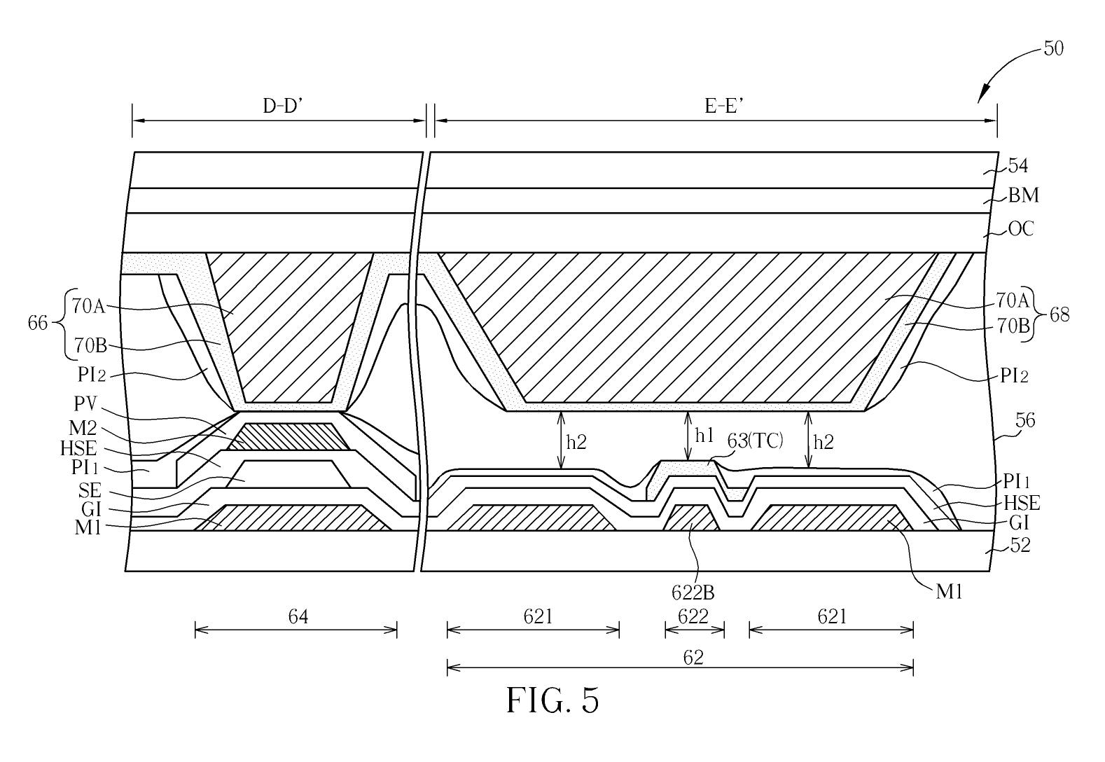

Please refer to FIG. 4 and FIG. 5. FIG. 4 illustrates a touch display panel according to a preferred embodiment of the present invention. FIG. 5 illustrates a cross-sectional view of the touch display panel along lines D-D′ and E-E′ in FIG. 4. To highlight the features of the present invention, FIG. 4 omits some elements such as the second substrate and the display medium layer. As shown in FIG. 4 and FIG. 5, the touch display panel 50 of the preferred embodiment includes a first substrate 52, a second substrate 54 disposed opposite to the first substrate 52, and a display medium layer 56 disposed between the first substrate 52 and the second substrate 54. In the embodiment, the touch display panel 50 is a liquid crystal touch display panel, and therefore the display medium layer 56 is a liquid crystal layer. The first substrate 52 is an array substrate (also known as TFT substrate), and the second substrate 54 is a counter substrate, but are not limited thereto. For example, if the touch display panel 50 is an organic electroluminescent touch display panel, the display medium layer 56 will be an electroluminescent material layer. Moreover, the first substrate 52 may be a counter substrate and the second substrate 54 may be an array substrate. The touch display panel 50 further includes a first gate line GL₁, a second gate line GL₂, a data line DL, a pixel switch device TFTₚᵢₓₑₗ, a pixel electrode 58, and a touch signal read-out lines RL disposed on the first substrate 52. The data line DL and the first gate line GL₁ are intersectedly arranged on the first substrate 52 and define a plurality of pixel areas 60 (also known as sub pixel areas). Each of the pixel areas 60 includes a pixel display area 60D and a pixel peripheral area 60P, and the pixel peripheral area 60P is disposed between the pixel display area 60D and the neighboring first gate line GL₁. Each of the pixel electrodes 58 is respectively disposed in the corresponding pixel display area 60D and electrically connected to a drain of the corresponding pixel switch device TFTₚᵢₓₑₗ. The touch signal read-out line RL is disposed in parallel to the data line DL and on one side of parts of the data lines DL. Moreover, the touch display panel 50 of the embodiment further includes a plurality of first stages 62, a plurality of second stages 64, and at least one touch signal read-out switch device TFT_{Readout} which are respectively disposed in one of the pixel peripheral areas 60P of the first substrate 52 and face the second substrate 54. A gate G_{Readout} and a drain D_{Readout} of the touch signal read-out switch device TFT_{Readout} are respectively electrically connected to the corresponding second gate line GL₂ and the touch signal read-out line RL. It is appreciated that the first gate line GL₁ and the second gate line GL₂ can be the same gate line.

The touch display panel 50 in the embodiment further includes a plurality of main spacers 66 and a plurality of conductive spacers 68. The main spacers 66 are disposed on the second substrate 54 and face the first substrate 52. The main spacers 66 correspond and contact the second stages 64, respectively, so that the touch display panel 50 can maintain a constant liquid crystal cell gap. The conductive spacers 68 are disposed on the second substrate 54 and face the first substrate 52. The conductive spacers 68 correspond to the first stages 62, and a gap is formed between the conductive spacer 68 and the corresponding first stage 62. Moreover, the surface of the conductive spacer 68 facing the first stage 62 is a flat surface but is not limited thereto. In this embodiment, the main spacers 66 and the conductive spacers 68 are made of the same material and patterned by the same process. For example, the main spacers 66 and the conductive spacers 68 can be made of a photo-sensitive insulated base 70A, and patterned by a lithography process. The surface of the conductive spacer 68 and/or the surface of the main spacer 66 may further dispose a surface conductive layer 70B, and the surface conductive layer 70B at least covers the surface, which faces the first stage 62, of the insulated base 70A. In this embodiment, the surface conductive layer 70B can also serve as a common electrode of the touch display panel 50, but is not limited thereto. For instance, the surface conductive layer 70B and the common electrode can also be conductive patterns which are not electrically connected to each other. Because of the design mentioned above, the main spacers 66 and the conductive spacers 68 may have substantially equal thickness but are not limited thereto. Moreover, other necessary devices for a liquid crystal display panel such as a black matrix BM and an overcoat layer OC may be disposed between the second substrate 54 and the main spacers 66 and between the second substrate 54 and the conductive spacers 68. Further, the second substrate 54 may also include a second alignment film PI₂ covering the surface of the main spacers 66 and the surface of the conductive spacers 68. It is appreciated that the second alignment film PI₂ has to expose the surface of the conductive spacers 68 which faces the first stages 62. In this embodiment, the second alignment film PI₂ exposes the surface conductive layer 70B. Also, the conductive spacer 68 protrudes out from the surface of the second substrate 54 and has a height difference. Due to the height difference, when forming the second alignment film PI₂, the second alignment film PI₂ will not be formed on the surface, which faces the first stage 62, of the conductive spacer 68. Therefore, no extra process for removing the second alignment film PI₂ is required.

The first stage 62 and the second stage 64 can be formed by stacking structural layers of different layers. For instance, the structural layers for forming the first stage 62 and the second stage 64 may be selected individually from the required layers for the liquid crystal display panel such as a first metal layer, a gate insulated layer, a semiconductor layer, a heavily doped semiconductor layer, a second metal layer, a passivation layer, and a transparent conductive layer, etc. In such a case, no extra masks are required to define the first stage 62 and the second stage 64. In this embodiment, the numbers of the constructing layers of the first stage 62 and the second stage 64 are different. For example, the stacking structure of the second stage 64 includes a first metal layer M1, a gate insulated layer GI, a semiconductor layer SE, a heavily doped semiconductor layer HSE, a second metal layer M2, and a passivation layer PV, while the stacking structure of the first stage 62 includes a first metal layer M1, a gate insulated layer GI, a heavily doped semiconductor layer HSE, and a transparent insulated layer TC (which is used as the conductive sensing pad 63). The layers of the stacking structure of the second stage 64 are more than the layers of the stacking structure of the first stage 62 so that the thickness of the second stage 64 is larger than the thickness of the first stage 62. The second stage 64 and the corresponding main spacer 66 construct the main spacer structure for maintaining the cell gap for the liquid crystal of the touch display panel 50, and the first stage 62 and the corresponding conductive spacer 68 construct the touch sensor structure for providing functions of both assistant supporting and touch input.

In the condition that the main spacer 66 and the conductive spacer 68 have substantially equal thickness, the main spacer 66 can contact the corresponding second stage 64 with a larger thickness so that the touch display panel 50 can maintain a constant cell gap for the liquid crystal. Because of the thinner thickness of the first stage 62, the first stage 62 will not contact the conductive spacer 68 when the touch display panel 50 is not pressed. Each of the first stages 62 includes one or more supporting structures 621, one or more sensing structures 622, and a conductive sensing pad 63 disposed on the sensing structure 622. The conductive sensing pad 63 is electrically connected to a source S_{Readout} of the touch signal read-out switch device TFT_{Readout}, and the conductive sensing pad 63 is disposed only on the sensing structure 622, not on the supporting structure 621. The conductive sensing pad 63 may be made of the same transparent conductive material as the pixel electrode 58 and defined by the same mask, but is not limited thereto. For example, the conductive sensing pad 63 can also made of a non-transparent conductive material. In this embodiment, a single touch signal read-out switch device TFT_{Readout} is able to read the signals received by multiple conductive sensing pads 63 so that the conductive sensing pads 63 which share the same touch signal read-out switch device TFT_{Readout} can be electrically connected to each other. For instance, parts of the conductive sensing pads 63 disposed on the same row can be electrically connected to each other by a connection line CL, and the connection line CL and the conductive sensing pads 63 can be made of the same or different conductive materials. Moreover, if the conductive sensing pads 63 that share the same touch signal read-out switch device TFT_{Readout} are disposed on different rows, the conductive sensing pads 63 can be connected to each other by the connection line CL disposed in parallel to the data line DL. Furthermore, a first alignment film PI₁ may be disposed on the first stages 62 and the second stages 64. The first alignment film PI₁ may cover the supporting structure 621, and may be regarded as a part of the supporting structure 621. The first alignment film PI₁, however, has to expose the conductive sensing pad 63. In this embodiment, there are a first gap h1 formed between the conductive spacer 68 and the conductive sensing pad 63, and a second gap h2 formed between the conductive spacer 68 and the supporting structure 621. The dimensions of the first gap h1 and the second gap h2 may be respectively adjusted to be equal or not, based on factors such as the required sub-supporting force, the elasticity of the second substrate 54, and the touch sensing sensitivity. In one embodiment, such as when the conductive sensing pad 63 uses ITO (indium tin oxide) as its transparent conductive material and the thickness is between 700 Å (angstrom) and 800 Å and when the thickness of the first alignment film PI₁ is between 300 Å and 400 Å, the first gap h1 will be less than the second gap h2. When implementing touch input by pressing the touch display panel 50, the sagging conductive spacer 68 will contact the supporting structure 621 of the first stage 62, and the supporting structure 621 will provide a sub-supporting force. Therefore, the durability of the touch display panel 50 can be prolonged. On the other hand, the surface conductive layer 70B of the sagging conductive spacer 68 will also contact the conductive sensing pad 63 disposed above the sensing structure 622 when pressing the touch display panel 50. Meanwhile, the touch input signal of the conductive spacer 68 will flow toward the touch signal read-out switch device TFT_{Readout} and reach the amplifier (which is not shown in the figure) through the conductive sensing pad 63 and the connection line CL, and thus the exact touch input position can be calculated by the a calculating unit (which is not shown in the figure).

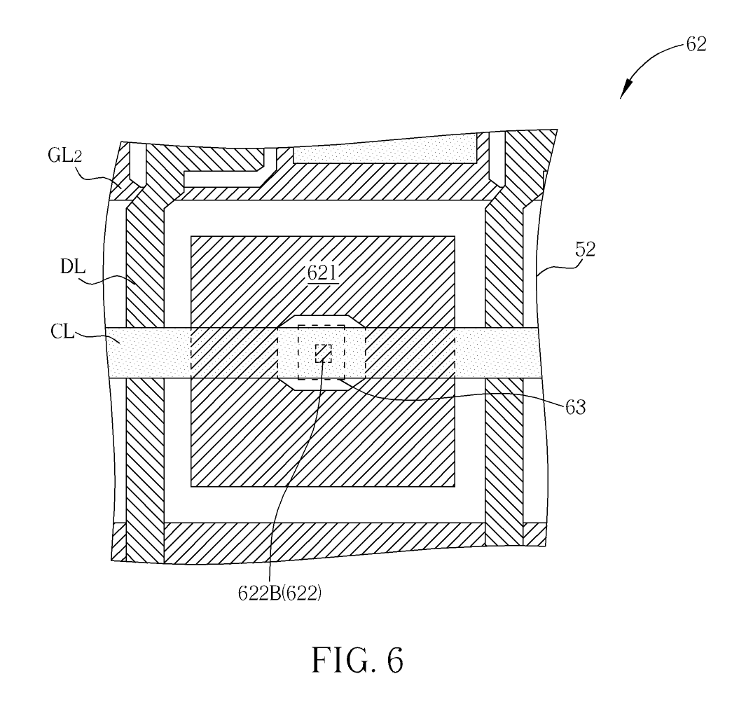

Please refer to FIG. 6. FIG. 6 illustrates a top view of the first stage in this embodiment. As shown in FIG. 6, in this embodiment, the sensing structure 622 is disposed inside the supporting structure 621. More specifically, the supporting structure 621 has a closed opening and the sensing structure 622 is correspondingly disposed inside the opening of the supporting structure 621 so that the supporting structure 621 surrounds the sensing structure 622. Moreover, the sensing structure 622 includes a prominent bulk 622B and the conductive sensing pad 63 is disposed above the prominent bulk 622B. The number and the shape of the prominent bulk 622B are not limited. Furthermore, the size of each of the prominent bulks 622B may be adjusted based on the requirement of the touch sensing sensitivity. For instance, the length or the width of each of the prominent bulks 622B may be less than 10 μm (micrometer), and preferably between 1 μm and 5 μm, but is not limited thereto.

The touch display panel and the touch sensor structure of the present invention are not limited to the above embodiment, and may have other embodiments or variations. Other embodiments and variation embodiments of the present invention are described below, and in order to compare the difference between the embodiments and to describe briefly, same components are denoted by same numerals, and repeated parts are not redundantly described.

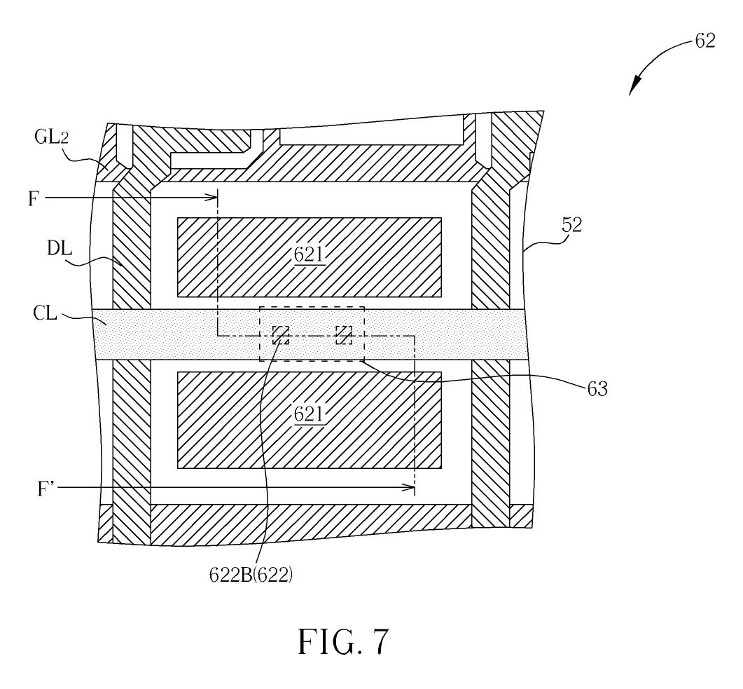

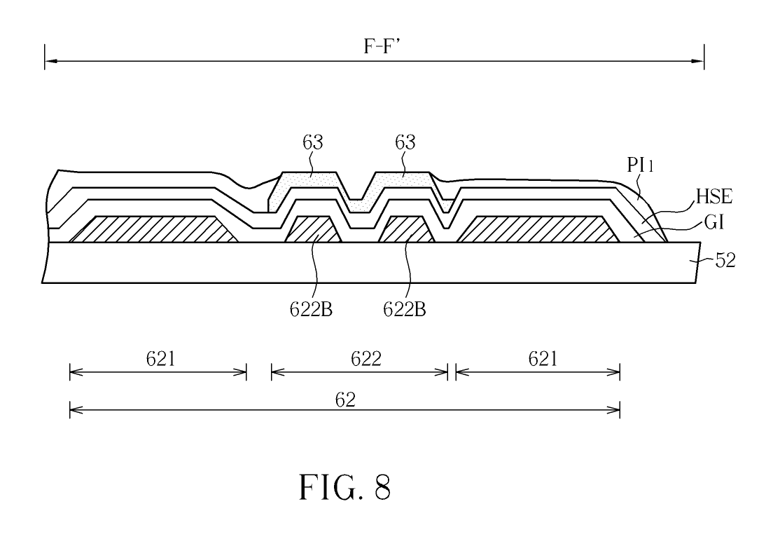

Please refer to FIG. 7 and FIG. 8. FIG. 7 illustrates a top view of a first stage of another embodiment of the present invention. FIG. 8 illustrates a cross-sectional view of the first stage along line F-F′ in FIG. 7. As shown in FIG. 7 and FIG. 8, the sensing structure 622 of this embodiment includes a plurality of prominent bulks 622B and the prominent bulks 622B have the same size. Moreover, in this embodiment, the sensing structure 622 is disposed between two supporting structures 621.

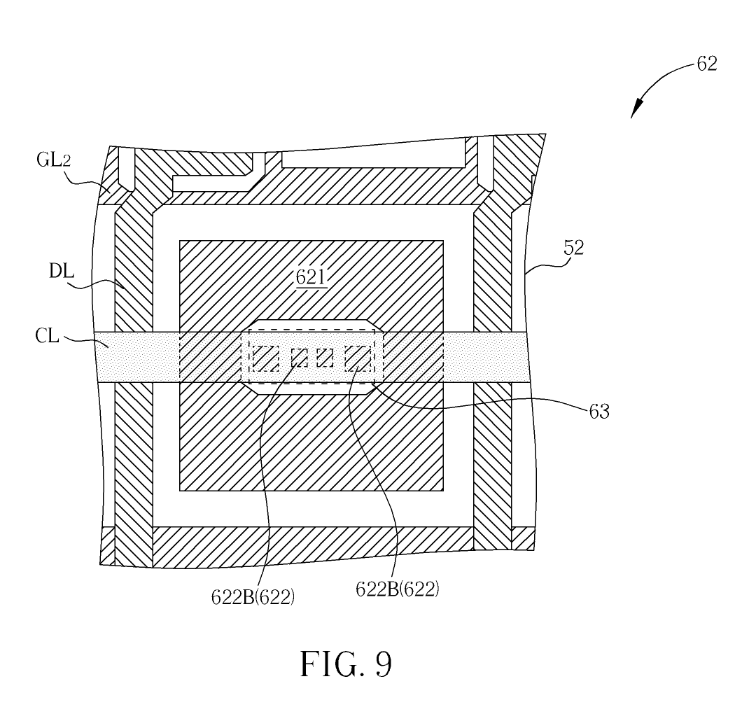

Please refer to FIG. 9. FIG. 9 illustrates a first stage of a variation embodiment of the present invention. As shown in FIG. 9, in this variation embodiment, the prominent bulks 622B of the sensing structure 622 have different sizes.

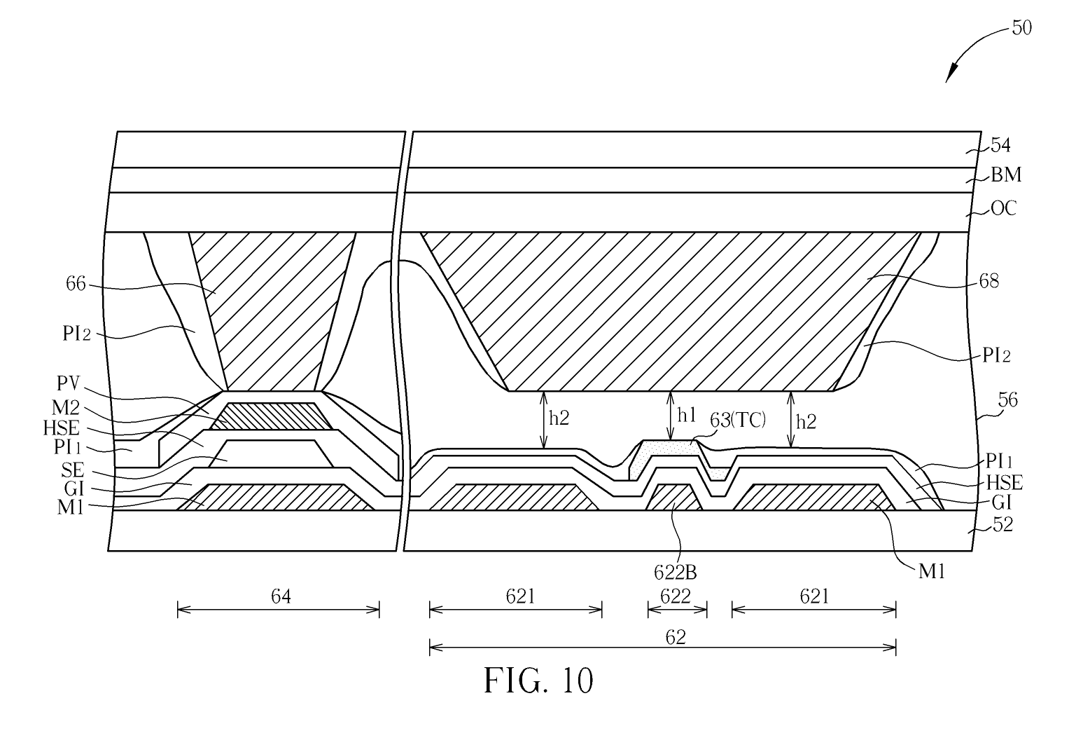

Please refer to FIG. 10. FIG. 10 illustrates a touch display panel of another preferred embodiment of the present invention. As shown in FIG. 10, different from the aforementioned embodiment in which the conductive spacer is formed by an insulated base and a surface conductive layer, the conductive spacer 68 in this embodiment is a monolithically-formed conductive spacer made of a conductive material. The monolithically-formed conductive spacer is that the conductive spacer is made of a single conductive material or composite conductive material, such as metal or alloy, and is formed monolithically. That is to say, the conductive spacer 68 is a conductor itself and does not need extra conductive layer to provide conductivity. Moreover, the conductive spacer 68 may be electrically connected to the common electrode (which is not shown in the figure) and share the common voltage or has an independent voltage.

Accordingly, the touch sensor structure of the present invention may provide dual functions of auxiliary supporting and touch input. Therefore, instead of making a choice between the numbers of the sub spacers and the numbers of the sensing spacers, the maximum numbers of the first stages having dual functions of auxiliary supporting and touch input can be disposed in the limited numbers of the pixel peripheral areas. Thus, the durability and the touch sensing sensitivity of the touch display panel are both greatly improved at the same time.

Those skilled in the art will readily observe that numerous modifications and alterations of the device and method may be made while retaining the teachings of the invention.

What is claimed is:

1. A touch sensor structure, comprising:
a first substrate;
a second substrate, disposed opposite to the first substrate;
a first stage, disposed on the first substrate and facing the second substrate, wherein the first stage comprises at least one supporting structure, a sensing structure, and a conductive sensing pad disposed on the sensing structure; and
a conductive spacer, disposed on the second substrate and facing the first substrate, wherein the conductive spacer is corresponding to the first stage.

2. The touch sensor structure according to claim 1, wherein a first gap is formed between the conductive spacer and the conductive sensing pad, a second gap is formed between the conductive spacer and the supporting structure, and the first gap is different from the second gap.

3. The touch sensor structure according to claim 1, wherein the conductive sensing pad is only disposed on the sensing structure.

4. The touch sensor structure according to claim 1, wherein the conductive spacer comprises an insulated base and a surface conductive layer, and the surface conductive layer at least covers a surface of the insulated base that faces the first stage.

5. The touch sensor structure according to claim 1, wherein the first stage comprises a plurality of supporting structures, and the sensing structure is disposed between the supporting structures.

6. The touch sensor structure according to claim 1, wherein the at least one of the supporting structures at least partially surrounds the sensing structure.

7. The touch sensor structure according to claim 1, wherein the sensing structure comprises a plurality of prominent bulks, and the conductive sensing pad is disposed above the prominent bulks.

8. The touch sensor structure according to claim 7, wherein at least a portion of the prominent bulks have different sizes.

9. The touch sensor structure according to claim 7, wherein a length or a width of the prominent bulk is between 1 micrometer (μm) and 5 μm.

10. A touch display panel, comprising:
a first substrate;
a plurality of first gate lines, disposed on the first substrate;
a plurality of data lines, disposed on the first substrate, wherein the data lines and the first gate lines are crossed to define a plurality of pixel areas, each of the pixel areas comprises a pixel display area and a pixel peripheral area, and the pixel peripheral area is disposed between the pixel display area and the neighboring first gate line;
a second substrate, disposed opposite to the first substrate;
a display medium layer, disposed between the first substrate and the second substrate;
a plurality of first stages, respectively disposed on one of the pixel peripheral areas of the first substrate and facing the second substrate, wherein each of the first stages comprises at least one supporting structure, a sensing structure, and a conductive sensing pad disposed on the sensing structure;
a plurality of conductive spacers, disposed on the second substrate and facing the first substrate, wherein each of the conductive spacers is respectively corresponding to one of the first stages;
a plurality of second stages, respectively disposed on one of the pixel peripheral areas of the first substrate and facing the second substrate; and
a plurality of main spacers, disposed on the second substrate and facing the first substrate, wherein each of the main spacers is corresponding to the second stage and in conduct with the second stage.

11. The touch display panel according to claim 10, wherein a first gap is formed between each of the conductive spacers and the corresponding conductive sensing pad of the first stage, a second gap is formed between each of the conductive spacers and the corresponding supporting structure of the first stage, and the first gap is different from the second gap.

12. The touch display panel according to claim 10, wherein the conductive sensing pad is only disposed on the sensing structure.

13. The touch display panel according to claim 10, wherein each of the first stages comprises a plurality of supporting structures, and the sensing structure is disposed between the supporting structures.

14. The touch display panel according to claim 10, wherein the at least one of the supporting structures of each of the first stages at least partially surrounds the sensing structure.

15. The touch display panel according to claim 10, further comprising at least one touch signal read-out switch device, disposed in one of the pixel peripheral areas of the first substrate, and the touch signal read-out switch device being electrically connected to at least a portion of the conductive sensing pads of the first stages.

16. The touch display panel according to claim 10, wherein the at least a portion of conductive sensing pads of the first stages are electrically connected to each other.

17. The touch display panel according to claim 10, further comprising a first alignment film and a second alignment film, wherein the first alignment film is disposed on the first substrate, at least exposing a part of the conductive sensing pad, and the second alignment film is disposed on the second substrate, at least exposing a part of the conductive spacer.

18. The touch display panel according to claim 10, wherein the main spacers and the conductive spacers substantially have an equal height, and a thickness of the second stage is larger than a thickness of the first stage.

19. The touch display panel according to claim 10, wherein each of the sensing structures comprises a plurality of prominent bulks, and each of the conductive sensing pads is disposed above the corresponding prominent bulks.

20. The touch sensor structure according to claim 19, wherein a length or a width of the prominent bulk is between 1 micrometer (μm) and 5 μm.
